(19) United States
(12) Patent Application Publication
(10) Pub. No.: US 2007/0168323 A1
(43) Pub. Date: Jul. 19, 2007

(54) Query aggregation

(75) Inventors: Howard J. Dickerman, Bellevue, WA (US); Kaicheng Hu, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/325,372

(22) Filed: Jan. 3, 2006

(51) Int. Cl. G06F 17/30

(52) U.S. Cl. 707/2

(57) ABSTRACT

An aggregated query is used to fetch data from a multidimensional database, such as an OLAP cube. The aggregated query combines individual queries that are used to fetch data from the multidimensional database into a single query. A determination is made as to what dimensions and hierarchies of the multidimensional database are used by the queries that are contained as cube functions within formulas in cells of a spreadsheet. Based on the dimensions and hierarchies that are used within the multidimensional database, a tuple for each of the individual queries is created that has the same dimensionality. These tuples having the same dimensionality are then combined to create the aggregated query.

### BACKGROUND

Spreadsheet software applications are used by many different users for manipulating data. Typical spreadsheet applications simulate physical spreadsheets by capturing, displaying, and manipulating data arranged in rows and columns. In addition to using spreadsheet applications, many users also store and utilize enormous amounts of data stored in multidimensional databases. These multidimensional databases are also known as OLAP cubes. These OLAP cubes are architecturally different from relational databases or object oriented databases and the language used to query and describe elements within the OLAP cubes is the Multi-Dimensional expression (MDX) language. OLAP systems analyze data drawn from other databases, often large relational databases such as data warehouses, or other multidimensional databases. The purpose of such analysis is to aggregate and organize business information into a readily accessible, easy to use multidimensional structure. Accessing the information within the OLAP cubes may sometimes be slow when accessing many different pieces of data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aggregated query is used to fetch data from a multidimensional database. The aggregated query may fetch data from multiple members (or tuples) that may be from different dimensions within an OLAP cube. The cube functions within spreadsheet cells are examined to determine the dimensions that are accessed within the cube. The aggregated query is then created by combining tuples having the same dimensionality. Using an aggregated query to fetch data from a multidimensional database can result in a significant performance increase as compared to fetching data using a single query for each requested element.

### BRIEF DESCRIPTION OF THE DRAWINGS

FIG. 1 illustrates an exemplary computing architecture for a computer;

FIG. 2 illustrates an overview of a spreadsheet system for accessing multidimensional data through the use of an aggregated query;

FIG. 3 illustrates a system for fetching data from OLAP cubes from cells of a spreadsheet application by creating an aggregated query; and

FIGS. 4 and 5 illustrate exemplary processes for fetching data from a multidimensional database using an aggregated query, in accordance with aspects of the present invention.

### DETAILED DESCRIPTION

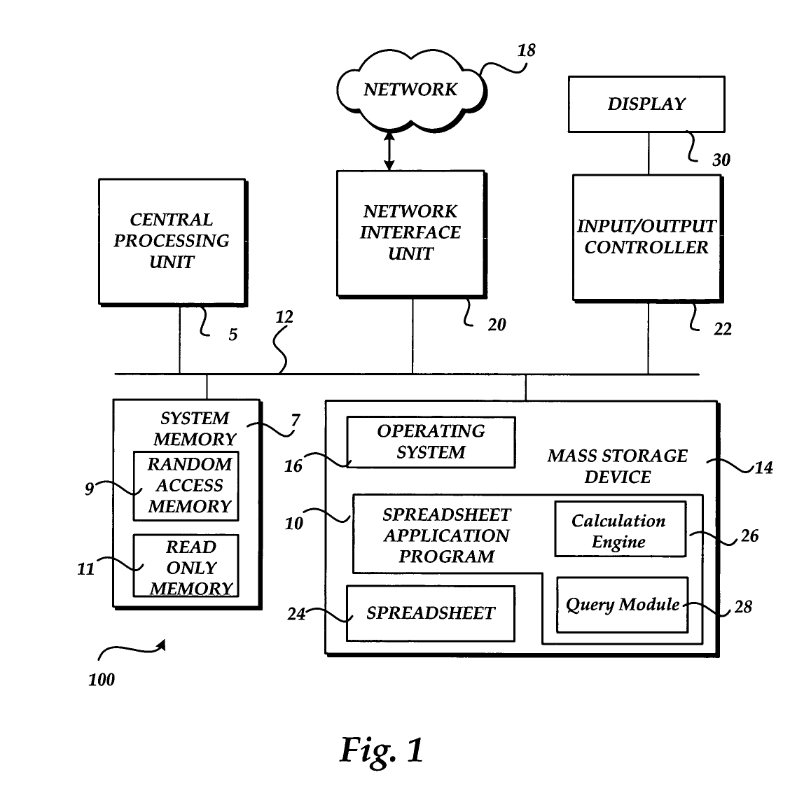

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Throughout the specification and claims, the following terms take the meanings explicitly associated herein, unless the context clearly dictates otherwise.

The term “MDX” refers to the MultiDimensional eXpressions language. The term “KPI” refers to a Key Performance Indicator.

The term “MDX Name” is a name as defined by MDX. The MDX unique name of a member is generally in the form

[Dimension].[Hierarchy].[Level].&[MemberKey] wherein all of these components are required. Non-unique names could have several other forms including [Member] or

[Dimension].[Member] or [Dimension].[Hierarchy].[All Member].[Parent Member].[Child Member].

The term “caption” refers to a non-unique friendly name to be displayed in the spreadsheet.

The term “connection” refers to the name of a data connection that has been stored within a spreadsheet workbook. Connection names are strings that uniquely identify connections within the workbook in which they are used. Identifying the connection also identifies the backend database (or OLAP cube) from which data is to be retrieved.

The term “cube” refers to the multi-dimensional OLAP database from which data is retrieved. The term “member” is a value along one of the cube's dimensions. For example, a member of a Time dimension might be “June 2003”. A member of a customers dimension might be “John Doe.”

The term “tuple” is the intersection of one or more members in a cube, with only one member from each dimension. The tuple represents the slice of the cube that includes the specified members. When a tuple contains only one member then that member and the tuple are identical to each other. The MDX Name for a tuple is of the form (<member1>, <member2> . . . <memberN>) where each <member> is replaced with the MDX name of that member. When an argument in a cube function refers to a range of cells that contain members (or tuples) these ranges are interpreted as tuples. For example, if cells A10 thru A13 of a spreadsheet contain members, then the cube function=CUBEMEMBER (“MyConnection”, $A10:$A13, D$2) has a tuple as its second argument. The term “set” is an ordered collection of one or more members (or tuples).

Briefly described, an aggregated query is used to fetch data from a multidimensional database, such as an OLAP cube. The aggregated query replaces a set of individual queries that could have been used to fetch data from the multidimensional database. The individual queries are defined by the use of cube functions within spreadsheet formulas. Instead of issuing a distinct query for each cube function, an aggregated query is designed which fetches data needed to evaluate multiple cube functions. According to embodiments, a determination is made as to what dimensions and hierarchies of the multidimensional database are used by the cube functions that are contained within cells of a spreadsheet. Based on the dimensions and hierarchies that are used within the multidimensional database, a tuple for each of the individual queries is created that has the same dimensionality. These tuples having the same dimensionality are then combined to create the aggregated query.

Referring now to FIG. 1, an exemplary computer architecture for a computer 100 utilized in various embodiments will be described. The computer architecture shown in FIG. 1 may be configured in many different ways. For example, the computer may be configured as a server, a personal computer, a mobile computer and the like. As shown, computer 100 includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, the computer 100 operates in a networked environment using logical connections to remote computers through a network 18, such as the Internet. The computer 100 may connect to the network 18 through a network interface unit 20 connected to the bus 12. The network interface unit 20 may also be utilized to connect to other types of networks and remote computer systems.

The computer 100 may also include an input/output controller 22 for receiving and processing input from a number of devices, such as: a keyboard, mouse, electronic stylus and the like. Similarly, the input/output controller 22 may provide output to a display 30, a printer, or some other type of device (not shown).

As mentioned briefly above, a number of program modules and data files may be stored in the mass storage device 14 and RAM 9 of the computer 100, including an operating system 16 suitable for controlling the operation of a networked computer, such as: the WINDOWS XP operating system from MICROSOFT CORPORATION; UNIX; LINUX and the like. The mass storage device 14 and RAM 9 may also store one or more program modules. In particular, the mass storage device 14 and the RAM 9 may store a spreadsheet application program 10, such as the MICROSOFT EXCEL spreadsheet application. The spreadsheet application 10 is operative to provide functionality for interacting with an OLAP data store through the use of an aggregated query that is constructed based on the individual queries that are entered into one or more cells of spreadsheet application 10. The spreadsheet is configured such that it generates the aggregated query to fetch data from the OLAP cube. The returned data is then used to populate the requesting cells.

The spreadsheet application 10 is configured to receive user input. For example, a user enters item data into a spreadsheet via a graphical user interface. The user input can be item data, item metadata, function information, cube function information, or other data. The user input may be direct input created by the user typing, pasting, or other deliberate action entering data into the spreadsheet or indirect input that may be generated by another program.

Calculation engine 26 performs operations relating to the cells within the spreadsheet 24. According to one embodiment, calculation engine 26 is a component within the spreadsheet application 10. The calculation engine 26, however, may be located externally from the spreadsheet application 10. The operations performed by calculation engine 26 may be mathematical, such as summation, division, multiplication, etc., or may include other functions or features, such as interacting with a multidimensional data store. Calculation engine 26 may be configured to perform many different operations.

Query module 28 is configured to create one or more aggregated queries that are based on the queries that are contained within spreadsheet 24 that are used to fetch data from one or more OLAP cubes. These cube queries may be included into one or more of the spreadsheet cells and are designed to query a selected database and then return the data to be used within the cell(s) of the spreadsheet 24. The requested data may be an aggregated value, a dimension member, a KPI, a member property, and the like. Query module 28 may be configured to create a single aggregated query that combines all of the queries within spreadsheet 24 to fetch data from an OLAP cube. The operation of query module 28 will be described in more detail below.

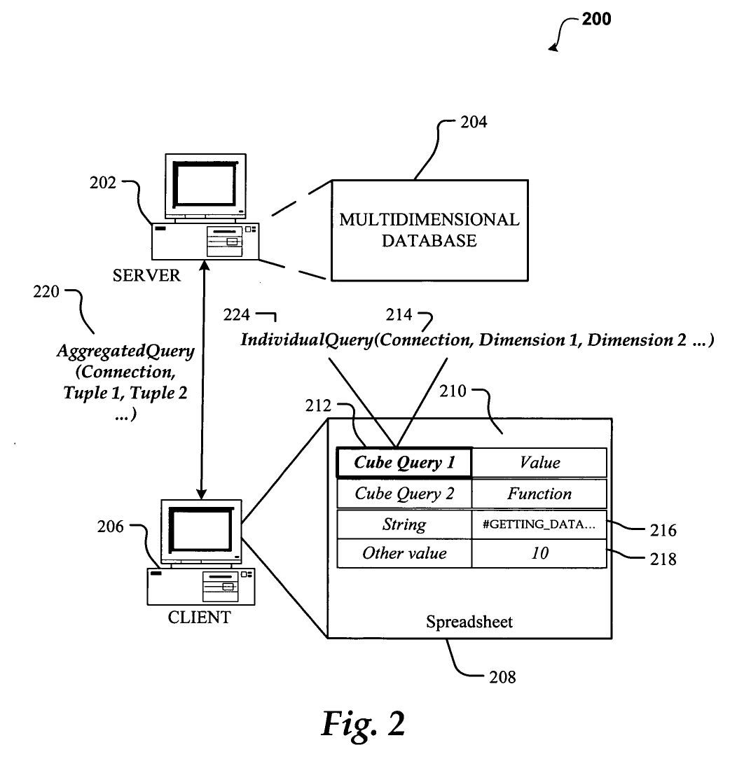

FIG. 2 illustrates an overview of a spreadsheet system 200 for accessing multidimensional data through the use of an aggregated query, in accordance with aspects of the invention. As illustrated, system 200 includes a server 202, which includes and/or is coupled to a multidimensional database 204, such as an OLAP data store. Server 202 is coupled to client 206 through a network connection. Client 206 includes a spreadsheet application 208. Spreadsheet application 208 includes spreadsheet cells 210. Typically, an active cell 212, which is highlighted by the dark border, is the cell within the spreadsheet that is currently being acted upon. For example, the user is entering an individual cube function 224 into the cell that requests data from an OLAP cube.

Zero or more of the spreadsheet cells may contain a cube function which is directed at interacting with and retrieving data from the multidimensional database 204. According to one embodiment, each cube function includes a connection parameter 214 that identifies the multi-dimensional database to access. According to one embodiment, the user may select a UI element, such as a dropdown, to choose from a list of available connections to OLAP cubes. The selected value is then included within the cube function.

Generally, a user may enter cube functions (i.e. 212) within one or more of the cells within spreadsheet 208 that request data to be fetched from the OLAP database 204. The functions contained within the cells to retrieve the data from the OLAP cube(s) may include MDX expressions as parameters that identify the location of the data using dimensions of the cube. Each of these functions includes connection information (214) that specifies the appropriate database and typically includes members from one or more dimensions. Generally, formulas within the spreadsheet can include the following: cube functions that will result in a query to an OLAP cube; dependent cube functions that query an OLAP cube but that also require the results of a different cube function as one of their arguments; standard spreadsheet functions that have a dependency on the values returned by the cube functions; and standard spreadsheet functions that have no dependency.

Communication between the spreadsheet application and the OLAP database 204 may be accomplished using MDX. Any other language, however, may be utilized that can communicate with an OLAP database. Furthermore, although the application is described herein as a spreadsheet, it will be appreciated that other applications, such as word processing applications that include spreadsheet cells, as well as other applications utilizing cells, may utilize an aggregated query to fetch data from a multidimensional database. The standard usage of the MDX language syntax does not permit a single query that asks for multiple members (or tuples) from different dimensions and/or hierarchies. To illustrate, a single query may not be used to fetch some members of the customer dimension and also some members of the product dimension. Sending a separate query for each member or tuple (i.e. for each cube function) can be very slow due to the overhead associated with each query.

MDX does, however, permit a single request for a large number of calculated measures in a single query. Therefore, the aggregated query requests information for a set of calculated measures. To illustrate, instead of querying for the member “[John Doe]” of the customer dimension, three calculated measures are requested: [John Doe]'s unique member name; [John Doe]'s caption; and [John Doe]'s level in the dimension. The following is exemplary syntax: [Measures].[John Doe]U as [John Doe].UniqueName; [Measures].[John Doe]C as [John Doe].Properties(“Caption”); and [Measures].[John Doe]L as [John Doe].Level.UniqueName.

Requesting the data as calculated measures fetches the MDX unique name, the display caption, and the hierarchy information for any given member. Additionally, as many members as desired may be combined within a single MDX query.

If each query within a spreadsheet were to be independently executed there may be a large number of small queries against the OLAP server 202. This could result in a significantly diminished performance for the spreadsheet application. As such, these individual queries that are within are combined into an aggregated query 220 before the data is fetched from the OLAP server. As illustrated, aggregated query 220 combines each cube query (cube query 1 and cube query 2) into a single aggregated query. Although a single aggregated query may be the most efficient to fetch data from the OLAP cube, the individual queries may be aggregated into some number of queries that is a smaller number as compared to the number of original queries. This results in fewer queries being made to the OLAP server, and as a result, the performance for the spreadsheet will be improved.

The spreadsheet cell calculations may be performed asynchronously. In other words, while data is being fetched from the OLAP server the calculations may continue within the other cells. Therefore, the calculations proceed for the cells that have no dependency on the result set, but are delayed for cells that are dependent. If the cell has no dependency on a query, the cell will get its value right away (218). If the cell has a dependency on the aggregated query, the cell is filled with a temporary error value of “#GETTING_DATA . . . ” (216) and the calculation proceeds to the next cell in the chain. This error shows the user that an action is being performed that relates to the cell.

When all of the cells have been evaluated, the spreadsheet triggers the aggregated query(s) needed to obtain data. This query is run asynchronously whenever possible. Asynchronous query processing may be desired so that the query won't block the spreadsheet applications UI thread and users can continue to work with the UI and can even abort the query when it's taking too long. As the values arrive for the cells that display the #GETTING_DATA . . . 216 error message, the error message is replaced with the fetched external data values and the calc is triggered for the cells that were dependent on the value that came in.

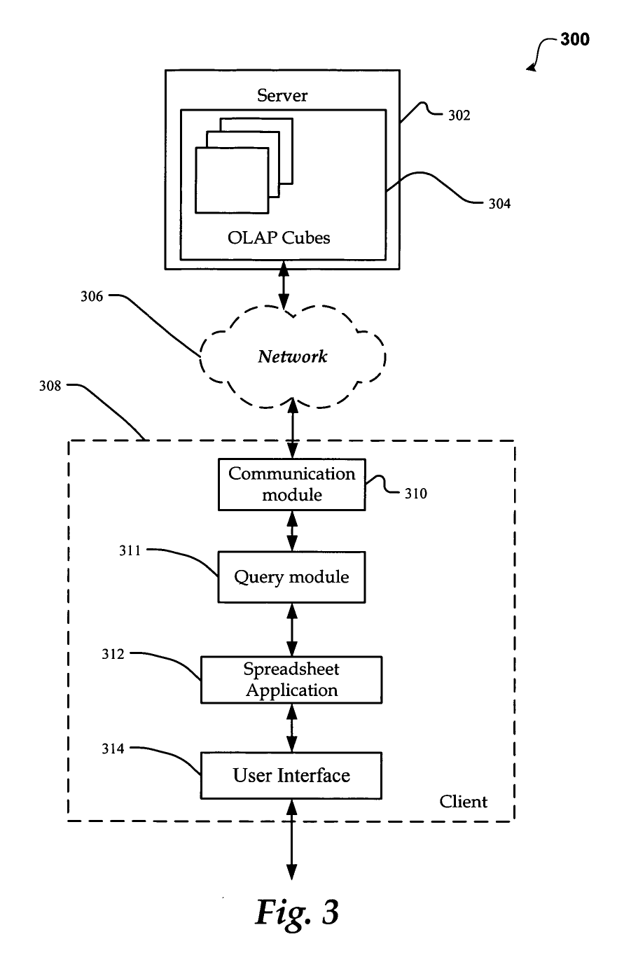

FIG. 3 illustrates a system 300 for fetching data from OLAP cubes from cells of a spreadsheet application by creating an aggregated query, in accordance with aspects of the invention. System 300 in this embodiment includes a server 302 which correspondingly has one or more databases stored thereupon 304. System 300 may optionally include a network 306 such as a LAN, WAN, the Internet or other network which server 302 may be coupled to.

System 300 includes client 308. Client 308 includes a communication module 310 that is coupled to a spreadsheet application 312. Furthermore, communication module 310 is coupled to the network 306. Communication module 310 may also be directly coupled to server 302 and/or directly to OLAP cube(s) 304.

When a user configures a new spreadsheet in spreadsheet application 312, they may chose from a list of OLAP cubes 304 to which it may connect. Alternatively, the user may type in the location of an OLAP cube to be connected. This link may then be given a connection name, such that this name is used by a query module 311 to construct an aggregated query for the named OLAP cube. Query module 311 is configured to determine the cells within the spreadsheet application 312 that are requesting data from an OLAP cube 304, analyze each query to determine the dimensionality and hierarchies that are accessed within the OLAP cube, and construct an aggregated MDX query that is passed on to server 302 (via communication module 310) to be interpreted. The appropriate cube 304 is then queried and, in response to the query, returns data from the database relating to the query to communication module 310. Communication module 310 then passes the data to the spreadsheet application 312, which in turn fills in the cell(s) with the data. When other cells within the spreadsheet depend upon the returned data, those cells may then be updated.

Communication module 310 may be located on client 308; however it may also be included on server 302 or may be included in cube(s) 304, among other locations. Communication module 310 is typically provided by cube(s) 304 such that the client 308 and spreadsheet application 312 may communicate with the cube(s) 304. In one embodiment, communication module 310 may comprise a dynamic-link library (DLL) that is provided (and configured) by the particular linked cube.

While query module 311 is shown as being separate from spreadsheet application 312, it may be included within the spreadsheet application 312. The location of query module 311 may also be other than in the client 308, such as within the server 302, or at some remote location.

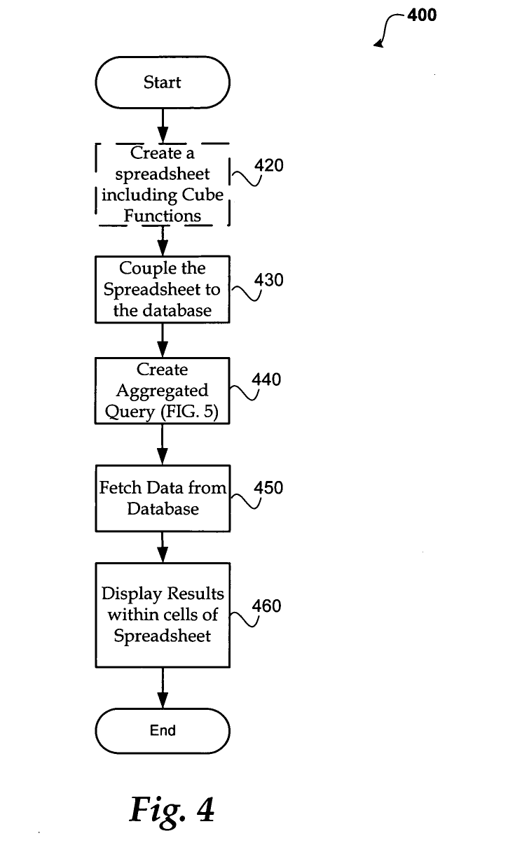

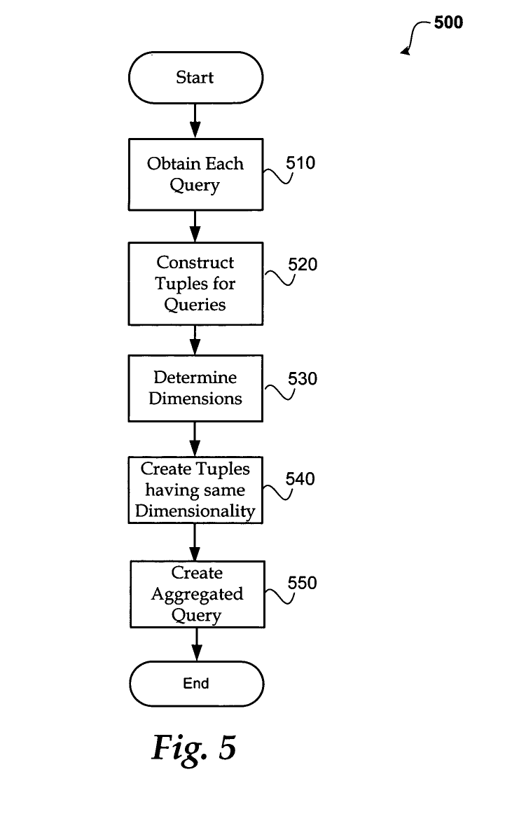

FIGS. 4 and 5 illustrate exemplary processes for fetching data from a multidimensional database using an aggregated query. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 4 displays an operational flow 400 for creating an aggregated query, in accordance with aspects of the invention. After a start operation, the process flows to operation 420, where a spreadsheet is created that includes requests for data from an OLAP cube. Generally, a user may create a spreadsheet from scratch in which all of the cells within the spreadsheet are defined, but, typically, a user may start with a spreadsheet that has at least been partially created. According to one embodiment of the invention, a cell may include zero or more cube functions, including items such as: retrieving a cube member; a cube value; a set from a cube; a KPI member function; a cube property function; and the like.

Flowing to operation 430, the spreadsheet is coupled to the database. When the spreadsheet is created and particular cells are defined within the spreadsheet to include queries that access a cube, different databases may be linked to the information in that cell and/or spreadsheet. In this way, each cell containing a cube function may be combined with other cube functions to fetch data from the appropriate OLAP data store.

Transitioning to operation 440, an aggregated query is created for the spreadsheet (See FIG. 5 and related discussion). According to one embodiment, an aggregated query is created for each OLAP cube from which data is requested. For example, when there are two OLAP cubes referenced within the cells of the spreadsheet, then there are two aggregated queries created.

Moving to operation 450, the aggregated query is then used to fetch the data relating from the multidimensional data stores. The cells within the spreadsheet may then be populated with the fetched data.

At operation 460, the results of the queries and any calculations that were performed may be displayed to the user. The process then moves to an end block and returns to processing other actions.

FIG. 5 shows a process for creating an aggregated query from cube queries that are contained within cells of a spreadsheet, in accordance with aspects of the invention.

After a start operation, the process flows to operation 510 where each query that requests data to be fetched from an OLAP cube is obtained. Generally, each query identifies the dimension and hierarchy from where to obtain the data from within a cube. Cells within a spreadsheet may contain many distinct formulas for fetching data from an OLAP cube. Generally, each formula fetches either: a member, a tuple, a value, a KPI, or a member property from the cube.

Moving to operation 520, each query for a member, tuple, or value is represented as a tuple. Each value within a cube can be represented by a tuple consisting of the value's coordinates. For example, in a cube with N dimensions, any value in the cube can be identified by a tuple that has N elements (X₁, X₂, X₃, . . . , X_{N}) where each element X in the tuple is a member on the given dimension. When the member on a particular dimension is the default member for that dimension then the member does not need not be specified in the tuple. For example, suppose that the spreadsheet includes cube queries to fetch M distinct values from the cube. In this case, M tuples identifying the M values are constructed. Each tuple may have up to N elements, where N is the number of dimensions in the cube.

Flowing to operation 530, the dimensions within the cube that are used by the cube queries is determined from the constructed tuples. Generally, the queries that are contained within the cells of the spreadsheet only fetch data from a limited number of available dimensions from the cube. For example, suppose that M values are examined, and across all M values, P hierarchies are referenced (where P is less than or equal to the number of dimensions (or hierarchies) in the cube (N above).

Moving to operation 540, the tuples previously constructed are modified to all have the same dimensionality. This means that each of the M tuples will have P elements (dimensionality=P). For example, when five dimensions are accessed by the cube queries, each of the tuples is modified to have five dimensions.

At operation 550, an aggregated query is created by combining all of the tuples into a single MDX query. In the aggregated query each tuple has the same dimensionality.

The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for fetching data from a multidimensional database, comprising:
determining cube queries that are contained within cells of a spreadsheet; wherein the cube queries require data to be fetched from the multidimensional database;
determining dimensions and hierarchies within the multidimensional database that are used by the cube queries; and
creating an aggregated query by combining the cube queries.

2. The computer-implemented method of claim 1, wherein determining the dimensions within the multidimensional database that are used by the cube queries comprises constructing a tuple for each of the cube queries and determining the dimensions from the tuples.

3. The computer-implemented method of claim 1, wherein creating the aggregated query by combining the cube queries comprises creating a tuple having a same dimensionality for each of the cube queries.

4. The computer-implemented method of claim 3, wherein creating the aggregated query comprises combining the tuples having the same dimensionality within an MDX query.

5. The computer-implemented method of claim 4, wherein the MDX query requests the data from the multidimensional database as calculated measures.

6. The computer-implemented method of claim 4, wherein the MDX query is a single MDX query that combines all of the cube queries within the cells of the spreadsheet.

7. The computer-implemented method of claim 6, further comprising fetching the data from the multidimensional database using the aggregated query.

8. The computer-implemented method of claim 6, further comprising placing the data within the spreadsheet.

9. The computer-implemented method of claim 6, further comprising calculating the cells within the spreadsheet asynchronously such that interaction with the spreadsheet may occur while the data is being obtained from the multidimensional database.

10. The computer-implemented method of claim 1, wherein creating the aggregated query by combining the cube queries further comprises constructing an aggregated query for each multidimensional database that is accessed by more than one cube query.

11. A computer-readable medium having computer-executable instructions for interacting with an OLAP cube, comprising:
parsing cube queries having parameters; wherein the cube queries may be included within cells of a spreadsheet and wherein the cube queries are directed at obtaining data from the OLAP cube;
determining dimensions of the OLAP cube that identify the data to be obtained from the OLAP cube;
creating a tuple having the determined number of dimensions for each of the cube queries;
creating a single aggregated query by combining the tuples having the determined number of dimensions; and
fetching the data from the OLAP cube using the single aggregated query.

12. The computer-readable medium of claim 11, wherein determining the dimensions of the OLAP cube comprises constructing a tuple for each of the cube queries and determining the dimensions from the tuples.

13. The computer-readable medium of claim 11, wherein creating the single aggregated query comprises creating an MDX query that requests the data from the multidimensional database as calculated measures.

14. The computer-readable medium of claim 11, further comprising fetching the data asynchronously such that interaction with a spreadsheet that contains the cube queries may occur while the data is being fetched.

15. The computer-readable medium of claim 11, wherein creating the single aggregated query comprises constructing a different aggregated query for each OLAP cube that is accessed.

16. A system for fetching data from a multidimensional database from a spreadsheet, comprising:
a spreadsheet application that is coupled to a network and is configured to perform steps, comprising:
including MDX queries within cells of the spreadsheet; wherein the MDX queries request data within the multidimensional database;
constructing an aggregated MDX query to request the data of the included MDX queries;
querying a server using the aggregated MDX query;
receiving data returned in response to the aggregated MDX query; and
updating the cell and any other dependent cells within the spreadsheet in response to the received data; and
the server that is coupled to a network and the spreadsheet application, and wherein the server, comprises:
an application that is configured to perform actions, comprising:
receive the aggregated MDX query; and
attempting to obtain the requested data; and when successful in obtaining the requested data delivering the data to the spreadsheet application.

17. The system of claim 16, wherein the spreadsheet application is further configured to determine dimensions within the multidimensional database that are used by the MDX queries.

18. The system of claim 17, wherein the spreadsheet application is further configured to create a tuple having a same dimensionality for each of the MDX queries.

19. The system of claim 18, wherein the spreadsheet application is further configured to combine the tuples having the same dimensionality within the aggregated MDX query.

20. The system of claim 19, wherein the MDX query requests the data from the multidimensional database as calculated measures.
